(19) United States
(12) Patent Application Publication
(10) Pub. No.: US 2026/0200756 A1
(43) Pub. Date: Jul. 16, 2026

(54) CATHODE ACTIVE MATERIALS WITH A CORE-SHELL STRUCTURE AND THEIR MANUFACTURE

(71) Applicant: BASF SE, Ludwigshafen am Rhein (DE)

(72) Inventors: Bohang SONG, Solon, OH (US); Jacob HAAG, Beachwood, OH (US); James A. SIOSS, Beachwood, OH (US)

(21) Appl. No.: 19/157,727

(22) PCT Filed: Feb. 26, 2024
(86) PCT No.: PCT/EP24/54802

§ 371 Date: Aug. 19, 2025

(30) Foreign Application Priority Data
Mar. 3, 2023 (EP) 23159855.8

(51) Int. Cl. C01G 53/506; H01M 4/02; H01M 4/36; H01M 4/525

(52) U.S. Cl. CPC C01G 53/506; H01M 4/366; H01M 4/525; C01P 2002/85; C01P 2004/03; C01P 2004/61; C01P 2004/84; C01P 2006/40; H01M 2004/021; H01M 2004/028

(57) ABSTRACT

Disclosed herein are cathode active materials including:
(A) a core material according to general formula Li₁₊ₓTM₁₋ₓO₂ where TM is a combination of Ni and at least two of Mn, Co and Al, and, optionally, at least one more metal selected from Mg, Ti, Zr, Nb, Ta, and W, and x is in the range of from −0.05 to +0.05, and where the nickel content is in the range of from 80 to 99 mol-% of TM,
(B) particles of cobalt compound(s) in which at least some cobalt is in the oxidation state of +III, and
(C) a shell including an oxide of at least one of B or W, and
   where the core material (A) is a polycrystalline material whose secondary particles are composed of primary particles, and particles of cobalt compounds (B) are enriched at the surface of said the secondary particles.

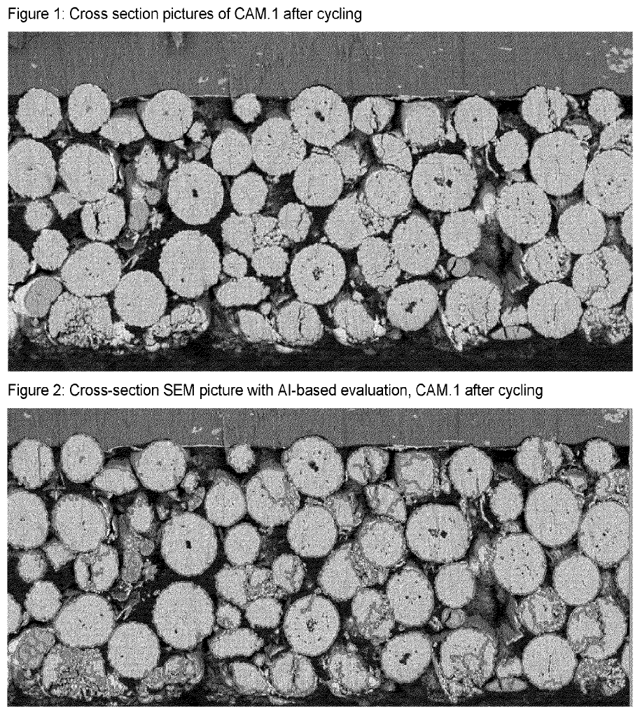

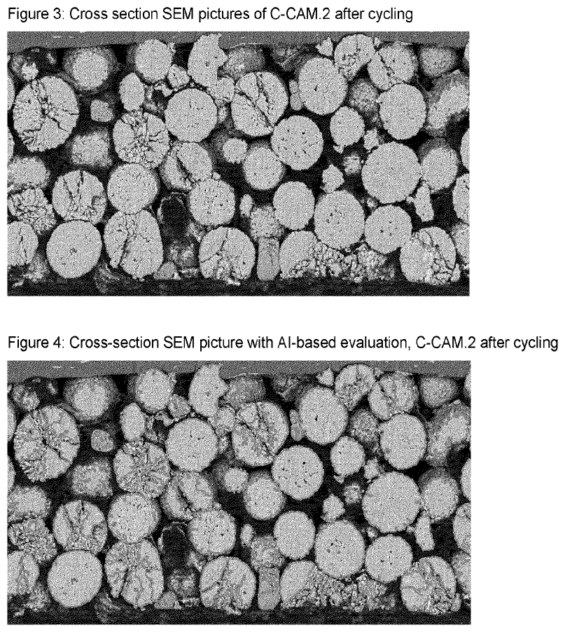

The Present Invention is Directed Towards Cathode Active Materials Comprising
(A) a core material according to general formula Li₁₊ₓTM₁₋ₓO₂ wherein TM is a combination of Ni and at least two of Mn, Co and Al, and, optionally, at least one more metal selected from Mg, Ti, Zr, Nb, Ta, and W, and x is in the range of from −0.05 to +0.05, and wherein the nickel content is in the range of from 80 to 99 mol-% of TM, and
(B) particles of cobalt compound(s) in which at least some cobalt is in the oxidation state of +III,
(C) a shell comprising an oxide of at least one of B or W,
   wherein the core material (A) is a polycrystalline material whose secondary particles are composed of primary particles, and particles of cobalt compounds (B) are enriched at the surface of said secondary particles.

Lithium-ion secondary batteries are modern devices for storing energy. Many application fields have been and are contemplated, from small devices such as mobile phones and laptop computers through car batteries and other batteries for e-mobility. Various components of the batteries have a decisive role with respect to the performance of the battery such as the electrolyte, the electrode materials, and the separator. Particular attention has been paid to the cathode materials. Several materials have been suggested, such as lithium iron phosphates, lithium cobalt oxides, and lithium nickel cobalt manganese oxides. Although extensive research has been performed, the solutions found so far still leave room for improvement.

Currently, a certain interest in so-called Ni-rich cathode active materials may be observed, for example cathode active materials that contain 60 mol-% or more of Ni, referring to the total content of metals other than lithium.

In U.S. Pat. No. 6,921,609, a process for making a cobalt-coated cathode active material has been disclosed. The disclosed cobalt-coated cathode active materials show improved electrochemical behaviour compared to non-coated equivalents. However, the specific capacity leaves room for improvement.

It was an objective of the present invention to provide cathode active materials with improved specific capacity and cycling performance, and reduced resistance growth. In addition, it was an objective to increase the conductivity and to avoid capacity loss through corrosion effects.

Accordingly, the cathode active material defined at the outset has been found, hereinafter also referred to as inventive cathode active material. Inventive cathode active material is a particulate material, and it comprises
(A) a core material according to general formula Li₁₊ₓTM₁₋ₓO₂ wherein TM is a combination of Ni and at least two of Mn, Co and Al, and, optionally, at least one more metal selected from Mg, Ti, Zr, Nb, Ta, and W, and x is in the range of from −0.05 to +0.05, and wherein the nickel content is in the range of from 80 to 99 mol-% of TM, and
(B) particles of cobalt compound(s) in which at least some cobalt is in the oxidation state of +III,
(C) a shell comprising an oxide of at least one of B or W,
   wherein the core material (A) is a polycrystalline material whose secondary particles are composed of primary particles, and particles of cobalt compounds (B) are enriched at the surface of said secondary particles.

Core material (A) and particles (B) and shell (C) will be described in more details below.

In one embodiment of the present invention core material (A) has an average particle diameter (D50) in the range of from 3 to 20 μm, preferably from 5 to 16 μm. The average particle diameter may be determined, e. g., by light scattering or LASER diffraction or electroacoustic spectroscopy. The particles of core material (A) are polycrystalline, that means that they are composed of a plurality of primary particles, and the above particle diameter refers to the secondary particle diameter.

The shape of the primary particles is preferably platelet-like as detected by SEM/TEM imaging.

A plurality means in this context that several hundred or even more primary particles form a secondary particle.

Core material (A) is preferably a nickel-rich cathode active material, that means that the molar percentage of nickel in core material is at least 80 mole-%, referring to all metals in TM, for example 80 to 99 mol-%.

TM in the above formula contains at least one of Mn, Co and Al, preferably at least two, e.g., Co and Mn, or Co and Al, or even all three, namely, Mn, Co, and Al.

Optionally, TM may contain at least one more metal selected from Mg, Ti, Zr, Nb, Ta, and W.

In one embodiment of the present invention, TM is a combination of metals according to general formula (I)

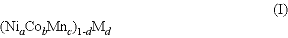

with
a being in the range of from 0.80 to 0.99, preferably from 0.83 to 0.95, more preferably from 0.85 to 0.91,
b being in the range of from 0.005 to 0.195, preferably from 0.025 to 0.13, and more preferably from 0.04 to 0.05,
c being in the range of from 0.005 to 0.195, preferably from 0.025 to 0.13, and more preferably from 0.04 to 0.05,
d being in the range of from zero to 0.1, preferably zero,
M is selected from Al, Mg, Ti, Zr, Nb, Ta and W, and combinations of at least two of the foregoing, preferably Al and Al and at least one of the foregoing, and

$$a + b + c = 1 .$$

### In Another Embodiment of the Present Invention, the Variable TM Corresponds to General Formula (Ia)

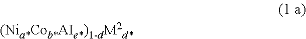

with a*+b*+e*=1 and
a* being in the range of from 0.80 to 0.99, preferably from 0.88 to 0.95,
b* being in the range of from 0.005 to 0.19, preferably from 0.025 to 0.1,
e* being in the range of from 0.002 to 0.19, preferably from 0.015 to 0.04,
d* being in the range of from zero to 0.1, preferably from zero to 0.02,
M² is at least one of Mg, W, Mo, Ti or Zr.

In one embodiment of the present invention TM corresponds to general formula (I) and x1 is in the range from −0.05 to +0.05, preferably from 0.01 to 0.05.

In one embodiment of the present invention TM corresponds to general formula (I a) and x1 is in the range of from −0.05 to +0.05.

Some elements are ubiquitous. In the context of the present invention, traces of ubiquitous metals such as sodium, calcium, iron or zinc, as impurities will not be taken into account in the description of the present invention. Traces in this context will mean amounts of 0.05 mol-% or less, referring to the total metal content of the TM or of particles (B), respectively.

Particles (B) comprise of lithium cobalt oxide compounds in which at least some cobalt is in the oxidation state of +III, preferably the majority cobalt. The oxidation state of cobalt in particles (B) may be determined by X-ray photoelectron spectroscopy (“XPS”), and the location relative to core material (A) may be determined by imaging processes such as transmission electron microscopy (“TEM”) and scanning electron microscopy (“SEM”). The phase type of particles (B) may be determined by high resolution X-ray powder diffraction (“XRD”). In a preferred embodiment, the average molar ratio of lithium to cobalt in particles (B) is in the range of from zero to below 1.

In one embodiment of the present invention, the average oxidation state of cobalt in particles (B) is in the range of from +2 to +4, preferably from above +2.5 to +3.5 and even more preferably +3.0.

The molar ratio of lithium to cobalt in particles (B) is in the range of from zero to 1, preferably from above zero to below 1, or it is 1:1.

At least some of the cobalt in particles (B) is in the oxidation state of +III. This includes the option that all of the cobalt in particles (B) is in the oxidation state of +III, for example like in LiCoO₂.

In one embodiment of the present invention, cobalt in particles (B) is in the form of at least one of Li_{y1} CoO₂ (0<y1<0.6) with spinel structure, LiCoO₂, and LiCo_{y2}Ni_{1-y2}O₂ (0.5<y2<1).

In a one embodiment, particles (B) are not composed of a defined compound but a mixture of several cobalt containing oxides, for example, sub-stoichiometric lithium cobalt oxide compounds such as Li_{0.5} CoO₂ combined with LiCoO₂.

More preferably, particles mainly comprise LiCoO₂, detectable by X-Ray diffraction (“XRD”) with Cu radiation, Kα1 wavelength=1.540598 Å.

In inventive cathode active materials, particles (B) are enriched at the surface of the secondary particles. Preferably, no particles (B) have migrated into the pores of the secondary particles.

In one embodiment of the present invention, the weight ratio of core material (A) and particles (B) is in the range of from 1000:1 to 10 to 1, preferably 100:1 to 20:1.

In one embodiment of the present invention, 20 to 45% of the secondary particles of inventive cathode active material exhibit cracks after 500 cycles of charging/discharging 4.2-3.0V at 40° C. when implemented in a cathode in a full cell with a graphite anode. Cracking is usually considered disadvantageous because a high number of cracks reduces the mechanical stability of a cathode, and cracks may reduce the migration of lithium ions.

In one embodiment of the present invention, particles (B) have an average diameter (D50) in the range of from 10 nm to 10 μm, preferably 10 nm to 1 μm. The average diameter (D50) may be determined by measuring the average diameter of the particles (B) on the surface of core material (A) using transmission electron microscopy (“TEM”) or scanning electron microscopy (“SEM”).

In one embodiment of the present invention, inventive cathode active materials further comprise aluminum compound(s) and titanium compound(s) or of zirconium compound(s), each being in particles (B).

In one embodiment of the present invention, particles (B) comprise cobalt and lithium and Al and at least one of Ti and Zr as additional elements, and it is preferred that particles (B) comprise more Co than any of Al, Ti and Zr. In embodiments wherein particles (B) comprise Al and at least one additional element selected from Ti and Zr, individual particles (B) may comprise both Li and Co and at least one of Ti, Zr and Al, but in other embodiments, individual particles comprise either cobalt or any of Ti, Zr or Al.

Preferably, though, particles (B) do not contain any of Al, Zr and Ti.

Particles of inventive cathode active material further comprise a shell (C). Shell (C) comprises an oxide of at least one of B or W, for example B₂O₃, WO₃, LiBO₂, Li₂B₄O₇, or Li₂WO₄. In a preferred embodiment, shell (C) contains at least 90% by weight of B₂O₃, WO₃, Li₂B₄O₇, Li₂WO₄, or LiBO₂. More preferably, shell (C) comprises an oxide of B, for example B₂O₃, LiBO₂, or Li₂B₄O₇, preferably at least 90% by weight.

In one embodiment of the present invention, shell (C) is glassy or amorphous, and no crystalline phase may be detected by X-ray diffraction.

In one embodiment of the present invention, shell (C) is not a complete shell but has holes, comparable to a Swiss cheese, for example with a coverage of from 55 to 95% of the outer surface of the secondary particles. In other embodiments, shell (C) is not coherent but shows an island structure.

In one embodiment of the present invention, the majority of the particles of inventive cathode active material is coated to at least some extent, for example 90 to 99% of all particles, determined by SEM/EDX imaging of an arbitrarily selected sample.

In one embodiment of the present invention, shell (C) has an average thickness in the range of from 2 nanometers to 50 nanometers, preferably 5 nanometers to 30 nanometers, detected by a depth-profile XPS.

In one embodiment of the present invention, B- or W-contained glassy phase fills into the grain boundaries between primary particles as deep as a few micrometers, preferably less than 3 μm, as confirmed by depth-profile XPS.

In one embodiment of the present invention inventive cathode active materials have a surface (BET) in the range of from 0.1 to 0.8 m²/g, determined according to DIN-ISO 9277:2003-05.

A further aspect of the present invention refers to electrodes comprising at least one electrode material active according to the present invention. They are particularly useful for lithium-ion batteries. Lithium-ion batteries comprising at least one electrode according to the present invention exhibit a good discharge behavior. Electrodes comprising at least one cathode active material according to the present invention are hereinafter also referred to as inventive cathodes or cathodes according to the present invention.

Cathodes according to the present invention can comprise further components. They can comprise a current collector, such as, but not limited to, an aluminum foil. They can further comprise conductive carbon and a binder.

Suitable binders are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethylcellulose, polyimides and polyvinyl alcohol.

In one embodiment of the present invention, binder is selected from those (co)polymers which have an average molecular weight Mw in the range from 50,000 to 1,000,000 g/mol, preferably to 500,000 g/mol.

Binder may be cross-linked or non-cross-linked (co)polymers.

In a particularly preferred embodiment of the present invention, binder is selected from halogenated (co)polymers, especially from fluorinated (co)polymers. Halogenated or fluorinated (co)polymers are understood to mean those (co)polymers which comprise at least one (co)polymerized (co) monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Inventive cathodes may comprise 1 to 15% by weight of binder(s), referring to cathode active material. In other embodiments, inventive cathodes may comprise 0.1 up to less than 1% by weight of binder(s).

A further aspect of the present invention is a battery, containing at least one cathode comprising inventive cathode active material, carbon, and binder, at least one anode, and at least one electrolyte.

Embodiments of inventive cathodes have been described above in detail.

Said anode may contain at least one anode active material, such as carbon (graphite), TiO₂, lithium titanium oxide, silicon or tin. Said anode may additionally contain a current collector, for example a metal foil such as a copper foil.

Said electrolyte may comprise at least one non-aqueous solvent, at least one electrolyte salt and, optionally, additives.

Non-aqueous solvents for electrolytes can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol % of one or more C₁-C₄-alkylene glycols. Polyalkylene glycols are preferably polyalkylene glycols having two methyl or ethyl end caps.

The molecular weight Mw of suitable polyalkylene glycols and in particular suitable polyethylene glycols can be at least 400 g/mol.

The molecular weight Mw of suitable polyalkylene glycols and in particular suitable polyethylene glycols can be up to 5,000,000 g/mol, preferably up to 2,000,000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and in particular 1,3-dioxolane.

Examples of suitable acyclic organic carbonates are dimethyl carbonate, ethyl methyl carbonate and diethyl carbonate.

Examples of suitable cyclic organic carbonates are compounds according to the general formulae (II) and (III)

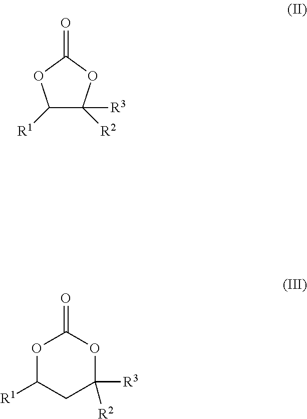

where R¹, R² and R³ can be identical or different and are selected from among hydrogen and C₁-C₄-alkyl, for example methyl, ethyl, n-propyl, isopropyl, n-butyl, isobutyl, sec-butyl and tertbutyl, with R² and R³ preferably not both being tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

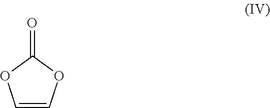

The solvent or solvents is/are preferably used in the water-free state, i.e., with a water content in the range from 1 ppm to 0.1% by weight, which can be determined, for example, by Karl-Fischer titration.

Electrolyte (C) further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F) 2, Li₂SiF₆, LiSbF₆, LiAlCl₄ and salts of the general formula (CₙF₂ₙ₊₁SO₂)ₜYLi, where m is defined as follows:
t=1, when Y is selected from among oxygen and sulfur,
t=2, when Y is selected from among nitrogen and phosphorus, and
t=3, when Y is selected from among carbon and silicon.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂) 2.

In an embodiment of the present invention, batteries according to the invention comprise one or more separators by means of which the electrodes are mechanically separated. Suitable separators are polymer films, in particular porous polymer films, which are unreactive toward metallic lithium. Particularly suitable materials for separators are polyolefins, in particular film-forming porous polyethylene and film-forming porous polypropylene.

Separators composed of polyolefin, in particular polyethylene or polypropylene, can have a porosity in the range from 35 to 45%. Suitable pore diameters are, for example, in the range from 30 to 500 nm.

In another embodiment of the present invention, separators can be selected from among PET nonwovens filled with inorganic particles. Such separators can have porosities in the range from 40 to 55%. Suitable pore diameters are, for example, in the range from 80 to 750 nm.

Batteries according to the invention further comprise a housing which can have any shape, for example cuboidal or the shape of a cylindrical disk or a cylindrical can. In one variant, a metal foil configured as a pouch is used as housing.

Batteries according to the invention display a good discharge behavior, for example at low temperatures (zero ° C. or below, for example down to −10° C. or even less), a very good discharge and cycling behavior.

Batteries according to the invention can comprise two or more electrochemical cells that combined with one another, for example can be connected in series or connected in parallel. Connection in series is preferred. In batteries according to the present invention, at least one of the electrochemical cells contains at least one cathode according to the invention. Preferably, in electrochemical cells according to the present invention, the majority of the electrochemical cells contains a cathode according to the present invention. Even more preferably, in batteries according to the present invention all the electrochemical cells contain cathodes according to the present invention.

The present invention further relates to the use of batteries according to the invention in appliances, in particular in mobile appliances. Examples of mobile appliances are vehicles, for example automobiles, bicycles, aircraft or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The present invention further relates to a process for manufacturing inventive cathode active materials, hereinafter also referred to as “inventive process” or “process according to the (present) invention”.

The inventive process comprises at least five steps, (a), (b), (c), (d) and (e), in the context of the present invention also referred to as step (a) and step (b) and step (c) and step (d) and step (e), respectively. Steps (a) and (b) and (d) and (e) are performed subsequently. Steps (b) and (c) may be performed consecutively or simultaneously.

### The Inventive Process Comprising the Steps of

(a) providing an oxide or (oxy) hydroxide of TM wherein TM is a combination of Ni and at least two of Mn, Co and Al, and, optionally, at least one more metal selected from Mg, Ti, Zr, Nb, Ta, and W, and wherein the nickel content is in the range of from 80 to 99 mol-% of TM,
(b) mixing said oxide or (oxy) hydroxide with an oxide or (oxy) hydroxide of cobalt, and, optionally, with at least one oxide or (oxy) hydroxide of Al, Nb, Ti or Zr, thereby obtaining a premix,
(c) adding a source of lithium to the premix obtained in step (b) in a molar ratio of Li to TM in the range of (1+x+y)/(1−x) wherein x is in the range of from zero to 0.05, and y is in the range of from zero to 0.1, thereby obtaining a mixture, and
(d) calcining the mixture of step (c),
(e) at least one post-treatment step selected from
(e1) treating calcined material from step (d) with water, followed by a liquid-solid separation step, and
(e2) adding a compound of W or preferably of B to the calcined material of step (d) or to the treated material from step (e1) and performing a thermal treatment at a temperature in the range of from 250 to 400° C.

Steps (a) to (e) will be explained in more detail below.

The inventive process starts off from a precursor for a cathode active material. The precursor is an oxide or (oxy) hydroxide of TM wherein TM is a combination of Ni and at least two of Mn, Co and Al, and, optionally, at least one more metal selected from Mg, Ti, Zr, Nb, Ta, and W, and wherein the nickel content is in the range of from 80 to 99 mol-% of TM. Said precursor may hereinafter also be referred to as “starting material”.

In one embodiment of the present invention, the starting material has an average particle diameter (D50) in the range of from 3 to 20 μm, preferably from 5 to 16 μm. The average particle diameter may be determined, e. g., by light scattering or LASER diffraction or electroacoustic spectroscopy. The particles are usually composed of agglomerates from primary particles, and the above particle diameter refers to the secondary particle diameter.

In one embodiment of the present invention, the starting material has a monomodal particle diameter distribution. In another embodiment of the present invention, the starting material has a bimodal particle diameter distribution.

In one embodiment of the present invention, the starting material has a narrow span of particle size distribution. The span may be expressed as (D90-D10)/(D50), and D90 and D10 are the respective percentile values.

In one embodiment of the present invention, when an (oxy) hydroxide is used as starting material, the starting material has a specific surface (BET), hereinafter also referred to as “BET surface”, in the range of from 3 to 50 m²/g. The BET surface may be determined by nitrogen adsorption after outgassing of the sample at 120° C. for 30 minutes or more and beyond this in accordance with DIN ISO 9277:2010.

In one embodiment of the present invention, when an oxide is used as starting material, the starting material has a BET surface, in the range of from 50 to 250 m²/g. The BET surface may be determined by nitrogen adsorption after outgassing of the sample at 120° C. for 30 minutes or more and beyond this in accordance with DIN ISO 9277:2010.

In one embodiment of the present invention, in step (a), an oxide of TM with a moisture content in the range of from zero to 100 ppm, is provided, determined by Karl-Fischer titration, preferred are 1 to 50 ppm. In this context, zero means “below detection level”.

Core material (A) is preferably a nickel-rich cathode active material. Although the percentage of nickel in core material may be 50 mole-% or even lower, e.g., 40 mole-%, it is preferred that the molar percentage of nickel in core material is at least 60 mole-%, referring to all metals in TM.

TM in the above formula contains at least one of Mn, Co and Al, preferably at least two, e.g., Co and Mn, Co and Al, or even Mn, Co, and Al.

Optionally, TM may contain at least one more metal selected from Mg, Ti, Zr, Nb, Ta, and W.

In one embodiment of the present invention, TM is a combination of metals according to general formula (I)

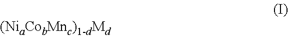

wherein
a is in the range of from 0.80 to 0.99, preferably from 0.83 to 0.95, more preferably from 0.85 to 0.91,
b is in the range of from 0.005 to 0.195, preferably from 0.025 to 0.13, and more preferably from 0.04 to 0.05,
c is in the range of from 0.005 to 0.195, preferably from 0.025 to 0.13, and more preferably from 0.04 to 0.05,
d is in the range of from zero to 0.1, preferably zero,

$$a + b + c = 1 .$$

In another embodiment of the present invention, the variable TM corresponds to general formula (Ia)

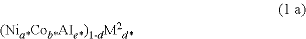

with a*+b*+e*=1 and
a* being in the range of from 0.80 to 0.99, preferably from 0.88 to 0.95,
b* being in the range of from 0.005 to 0.19, preferably from 0.025 to 0.1,
e* being in the range of from 0.002 to 0.19, preferably from 0.015 to 0.04,
d* being in the range of from zero to 0.1, preferably from zero to 0.02,
M² is at least one of Mg, W, Mo, Ti or Zr.

The starting material provided in step (a) is usually free from conductive carbon, that means that the conductive carbon content of starting material is less than 1% by weight, referring to said starting material, preferably 0.001 to 1.0% by weight.

The starting material provided in step (a) usually free from lithium. That means that the lithium content in the starting material provided in step (a) is lower than 0.1% by weight, referring to starting material, preferably in the range of from zero to 100 ppm. Lithium compounds in the starting material are usually impurities.

Again, some elements are ubiquitous. In the context of the present invention, traces of ubiquitous metals such as sodium, calcium, iron or zinc, as impurities will not be taken into account. Traces in this context will mean amounts of 0.05 mol-% or less, referring to the total metal content of the starting material.

In step (b), said starting material is contacted with an oxide or (oxy) hydroxide of cobalt and, optionally, up to 10% by vol of water and, optionally, at least one oxide or hydroxide or oxyhydroxide of Ti, Zr or Al or Nb, wherein said oxide or (oxy) hydroxide of cobalt has an average particle diameter (D50) in the range of from 10 nm to 50 μm and a span of the particle diameter distribution in the range of from 0.5 to 3.5, followed by mixing.

Examples of oxides and hydroxides of cobalt are CoO, Co₃O₄, Co(OH)₂, CoOOH, and nonstoichiometric oxyhydroxides of cobalt. Preferred are Co(OH)₂ and Co₃O₄.

Examples of optionally added oxide or hydroxide or oxyhydroxide of Ti, Zr, Nb or Al are TiO₂, Ti₂O₃, TiO(OH)₂, TiO₂·aq, Al₂O₃, AlOOH, Al(OH)₃, Al₂O₃·aq, ZrO₂, Zr(OH)₄, and ZrO₂·aq as well as Nb₂O₅ and Nb₂O₅·aq (“niobic acid”).

Step (b) may be performed by mixing the respective components in a mixer, for example in a high-shear mixer. For laboratory scale experiments, ball mills and roller mills may be applied as well.

In one embodiment of the present invention, the molar ratio of cobalt added in step (b) is in the range of from 0.5 to 5% of TM, preferably 1 to 3%.

Step (b) may be performed with the addition of water or of an organic solvent but it is preferred to not add any organic solvent or water in sub-step (b) or in any sub-step.

Preferred duration of step (b) is in the range of from one to 60 minutes.

In one embodiment of the present invention, step (b) is performed by charging a vessel with starting material provided in step (a) and adding an oxide or (oxy) hydroxide of cobalt.

A premix is obtained in step (b).

Step (c) includes adding a source of lithium to the premix obtained in step (b) in a molar ratio of Li to TM in the range of (1+x+y)/(1−x) wherein x is in the range of from zero to 0.05, and y is in the range of from zero to 0.1, thereby obtaining a mixture. Suitable sources of lithium are LiOH, with or with hydrate, Li₂ CO₃, and Li₂O₂ and mixtures of at least two of the foregoing, for example mixtures of LiOH and Li₂O₂.

Step (c) may be performed in the same vessel as step (b).

Step (d) includes calcining the mixture obtained from step (b), for example at a temperature in the range of from 550 to 800° C., preferably 575 to 775° C.

Step (d) may be carried out in any type of oven, for example a roller hearth kiln, a pusher kiln, a rotary kiln, a pendulum kiln, or—for lab scale trials—in a muffle oven.

The temperature of 550 to 800° C. corresponds to the maximum temperature of step (d).

It is possible to subject the mixture obtained from step (c) directly to step (d). However, it is preferred to increase the temperature stepwise, or to ramp up the temperature. Said step-wise increase or ramping up may be performed under normal pressure or under reduced pressure, for example 1 to 500 mbar.

Step (d)—at its maximum temperature—may be performed under normal pressure.

Step (d) is carried out under an oxygen-containing atmosphere, for oxygen-enriched air with at least 80 vol-% of oxygen, or under pure oxygen.

In one embodiment of the present invention, step (d) is carried out under an atmosphere with reduced CO₂ content, e.g., a carbon dioxide content in the range of from 0.01 to 500 ppm by weight, preferred are 0.1 to 50 ppm by weight. The CO₂ content may be determined by, e.g., optical methods using infrared light. It is even more preferred to perform step (d) under an atmosphere with a carbon dioxide content below detection limit for example with infrared light-based optical methods.

In one embodiment of the present invention, step (d) is performed in a roller hearth kiln, a pusher kiln or a rotary kiln or a combination of at least two of the foregoing. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well.

In one embodiment of the present invention, step (d) of the present invention is performed under a forced flow of gas, for example air, oxygen and oxygen-enriched air. Such stream of gas may be termed a forced gas flow. Such stream of gas may have a specific flow rate in the range of from 0.5 to 15 m³/h·kg mixture from step (c). The volume is determined under normal conditions: 298 Kelvin and 1 atmosphere. Said forced flow of gas is useful for removal of gaseous cleavage products such as water.

In one embodiment of the present invention, step (d) has a duration in the range of from two to 30 hours. Preferred are 6 to 24 hours. The cooling time is neglected in this context.

The inventive process contains a post-treatment step selected from the steps (e1) and (e2), namely
a step (e1) of treating the material obtained from step (d) with an aqueous medium, preferably with water, followed by a liquid-solid separation step, and/or
a step (e2) of adding a compound of tungsten or preferably of boron to the material obtained from step (d) or (e1), respectively, and a subsequent thermal treatment.

More preferably, the inventive process comprises both steps (e1) and (e2). Steps (e1) and (e2) are described in more detail below.

In said optional step (e1), said cathode active material obtained from step (d) is treated with an aqueous medium, preferably with water or with an aqueous solution of LiOH. Said aqueous medium may have a pH value in the range of from 7 up to 14, preferably at least 3.5, more preferably from 5 to 7 or 10 to 13. The pH value is measured at the beginning of step (e1). It is observed that in the course of step (e1), the pH value raises to at least 10, for example 11 to 13. In embodiments wherein the pH value is in the range of from 10 to 11 at the beginning of step (e1) it raises to more than 11 to up to 13. In embodiments wherein the pH value is in the range of 3 to below 10 at the beginning of step (e1) it raises to 11 to up to 13 in the course of step (e1).

It is preferred that the water hardness of said aqueous medium used in step (e1) is at least partially removed, especially calcium. The use of desalinized water is preferred.

The pH value of said aqueous medium is influenced by substances dissolved or slurried in said aqueous medium, for example acidic compounds such as sulfuric acid or aluminum sulfate, or bases such as LiOH or NaOH. In a preferred embodiment, such aqueous medium is water.

In one embodiment of the present invention, step (e1) is performed at a temperature in the range of from 5 to 85° C., preferred are 5 to 30° C.

In one embodiment of the present invention, step (e1) is performed at normal pressure. It is preferred, though, to perform step (e1) under elevated pressure, for example at 10 mbar to 10 bar above normal pressure, or with suction, for example 50 to 250 mbar below normal pressure, preferably 100 to 200 mbar below normal pressure.

Step (e1) may be performed, for example, in a vessel that can be easily discharged, for example due to its location above a filter device. Such vessel may be charged with material from step (d) followed by introduction of aqueous medium. In another embodiment, such vessel is charged with aqueous medium followed by introduction of material from step (d). In another embodiment, material from step (d) and aqueous medium are introduced simultaneously.

In one embodiment of the present invention, in step (e1), the amounts of water and electrode active material have a weight ratio in the range of from 1:5 to 5:1, preferably from 2:1 to 1:2.

Step (e1) may be supported by mixing operations, for example shaking or in particular by stirring or shearing, see below.

In one embodiment of the present invention, step (e1) has a duration in the range of from 1 minute to 90 minutes, preferably 1 minute to less than 60 minutes. A duration of 5 minutes or more is possible in embodiments wherein in step (e1), water treatment and water removal are performed overlapping or simultaneously.

In one embodiment of the present invention, treatment according to step (e1) and removal of the aqueous medium are performed consecutively.

After or during the treatment with an aqueous medium in accordance to step (e1), water may be removed by any type of filtration, for example on a band filter or in a filter press.

In one embodiment of the present invention, at the latest 5 minutes after commencement of step (e1), the removal of aqueous medium is started. Such removal includes partially removing the water from treated particulate electrode active material, for example by way of a solid-liquid separation, for example by decanting or preferably by filtration. Said “partial removal” may also be referred to as partially separating off.

In one embodiment of the present invention, the slurry obtained in step (e1) is discharged directly into a centrifuge, for example a decanter centrifuge or a filter centrifuge, or on a filter device, for example a suction filter or in a filter press or in a belt filter that is located preferably directly below the vessel in which step (b) is performed. Then, filtration is commenced.

In a particularly preferred embodiment of the present invention, steps (e1) and the removal of the aqueous medium are performed in a filter press or in a filter device with stirrer, for example a pressure filter with stirrer or a suction filter with stirrer (German for example: “Rührfilternutsche”). At most 5 minutes after, preferably at most 3 minutes after- or even immediately after—having combined starting material and aqueous medium in accordance with step (e1), removal of aqueous medium is commenced by starting the filtration. On laboratory scale, treatment with and removal of the aqueous medium may be performed on a Büchner funnel be supported by manual stirring.

In a preferred embodiment, step (e1) is performed in a filter device, for example a stirred filter device that allows stirring of the slurry in the filter or of the filter cake.

In one embodiment of the present invention, the aqueous medium or water removal in accordance with step (e1) has a duration in the range of from 1 minute to 1 hour.

In one embodiment of the present invention, stirring in step (e1) is performed with a rate in the range of from 1 to 50 revolutions per minute (“rpm”), preferred are 5 to 20 rpm. In other embodiments, it is 200 to 400 rpm.

In one embodiment of the present invention, filter media may be selected from ceramics, sintered glass, sintered metals, organic polymer films, non-wovens, and fabrics.

In one embodiment of the present invention, step (e1) is carried out under an atmosphere with reduced CO₂ content, e.g., a carbon dioxide content in the range of from 0.01 to 500 ppm by weight, preferred are 0.1 to 50 ppm by weight. The CO₂ content may be determined by, e.g., optical methods using infrared light. It is even more preferred to perform step (e1) under an atmosphere with a carbon dioxide content below detection limit for example with infrared-light based optical methods.

From step (e1), a solid residue is obtained, preferably in the form of a wet filter cake. The moisture content of the solid residue and especially of the filter cake may be in the range of from 3 to 20% by weight, preferably 4 to 9% by weight.

After step (e1), drying may be performed, for example under nitrogen or under reduced pressure (“in vacuo”) at 50 to 150° C., to obtain a free-flowing powder.

Step (e2) includes adding a compound of B or W, preferably of boron to the calcined mixture of step (d) or to the material obtained from step (e1), respectively, and performing a thermal treatment at a temperature in the range of from 250 to 400° C.

Examples of compounds of tungsten are WO₃, (NH₄)₂WO₄, Li₂WO₄, and Li₄WO₅.

Examples of compounds of boron are B₂O₃, boric acid (B(OH)₃) and lithium borates, for example LiBO₂. Boric acid is preferred. Said compound of boron may be added in bulk or in solution, for example as aqueous solution.

Combinations of compounds of tungsten and of boron are possible as well.

In a preferred embodiment, step (e2) is performed as indicated above but with no drying, and a compound of boron is added to the moist or even wet filter cake.

In one embodiment of the present invention, the material obtained from step (d) is allowed to interact, for example in the range of from 10 minutes to 5 hours and at a temperature of from 5 to 85° C.

In one embodiment of the present invention, the amount of compound of tungsten or, preferably, of boron added in step (e2) is in the range of from 0.05 to 1.5 mol-%, preferably 0.15 to 0.9 mol-%, referring to TM.

Subsequently to the addition of compound of tungsten or boron a thermal treatment is performed. Said thermal treatment may be carried out in any type of oven, for example a roller hearth kiln, a pusher kiln, a rotary kiln, a pendulum kiln, or—for lab scale trials—in a muffle oven.

The temperature of said thermal treatment in step (e2) may be in the range of from 250 to 400° C. Said temperature refers to the maximum temperature of step (e2).

In one embodiment of the present invention, the temperature is ramped up before reaching the desired temperature of from 250 to 400° C. For example, first the mixture of step (e2) is heated to a temperature to 250 to 300° C. and then held constant for a time of 10 min to 4 hours, and then it is raised to 325 to 400° C.

In one embodiment of the present invention, the heating rate in step (e2) is in the range of from 0.1 to 10° C./min.

In one embodiment of the present invention, the heat treatment step (e2) is performed in a roller hearth kiln, a pusher kiln or a rotary kiln or a combination of at least two of the foregoing. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well.

In one embodiment of the present invention, the heat treatment in step (e2) is performed in an oxygen-containing atmosphere, for example in a nitrogen-air mixture, in a rare gas-oxygen mixture, in air, in oxygen or in oxygen-enriched air or in pure oxygen. In a preferred embodiment, the atmosphere in step (e2) is selected from air, oxygen and oxygen-enriched air. Oxygen-enriched air may be, for example, a 50:50 by volume mix of air and oxygen. Other options are 1:2 by volume mixtures of air and oxygen, 1:3 by volume mixtures of air and oxygen, 2:1 by volume mixtures of air and oxygen, and 3:1 by volume mixtures of air and oxygen. Pure oxygen is even more preferred.

In one embodiment of the present invention, the heat treatment in step (e2) has a duration in the range of from 30 minutes to 5 hours. Preferred are 60 minutes to 4 hours. The cooling time is neglected in this context.

The invention is further illustrated by working examples.

### General:

### Particle Cracking is Measured as Follows:

(1) artificial intelligence (“AI”) is trained to recognize polished cross-section of the particles of cathode active materials, and to ignore sub-surface features of cathode active material particles;
(2) only the exterior perimeter of the cathode active materials particles is traced because it is in contact with electrolyte, ignoring interior voids that should not have access to electrolyte;
(3) the polished cross-sectional area of the cathode active material particles is determined;
(4) total perimeter divided by the polished cross-sectional area (for normalization purpose), and use it as a quantifiable measure of cracking. That is, the higher the P/A ratio, the more extensive is the cracking of said cathode active material.

### I. CATHODE ACTIVE MATERIALS

### I. 1. Preparation of Precursor, Step (a.1)

A stirred tank reactor was first filled with deionized water with ammonium sulfate added (49 g per kg water). The solution was controlled to be 55° C. and the pH value to be 12 by adding aqueous sodium hydroxide solution.

The tank reactor was simultaneously fed with an aqueous transition metal sulfate solution and an aqueous sodium hydroxide solution at a flow rate ratio of 1.8, and a total flow rate leading to a residence time of 8 hours. The transition metal sulfate solution contained Ni, Co, Mn in a molar ratio of 91:4.5:4.5 and the total transition metal concentration was 1.45 mol/kg. The aqueous sodium hydroxide solution was a mixture between sodium hydroxide solution (50 wt. %) and ammonia solution (30 wt. %) in a weight ratio of 6. The pH value 12 was kept by a separate feed of aqueous sodium hydroxide solution. Beginning with the start-up of all feeds, mother liquor was continuously removed. After 27 hours all feed flows were stopped. The mixed transition metal (TM) oxyhydroxide precursor TM-OH. 1 was obtained by filtration of resulting suspension, washing with distilled water, drying at 120° C. in air, and sieving.

The oxyhydroxide precursor TM-OH. 1 so obtained was then calcined at 475° C. to produce the oxide precursor TM-O.1.

### 1.2. Preparation of Cathode Active Materials (Pristine), Step (b.1) to (d.1)

The oxide precursor TM-O.1 was mixed with 1.0 mole-% Co(OH)₂, 1.6 mole-% Al(OH)₃, and 0.3 mole-% ZrO₂, all mole-% referring to the sum of Ni, Co, and Mn in the TM-O.1, and the LiOH monohydrate with a Li/TM molar ratio of 1.03. The mixture was heated to 765° C. for 8 hours in a forced flow of oxygen to obtain the cathode active material B-CAM.1.

In a comparative sample, the same mixture was made except that the Co(OH)₂ was not added. After calcining the mixture, comparative cathode active material C-B.CAM.2 was obtained.

D50=12.6 μm measured using laser diffraction technique in a Mastersizer 3000 instrument from Malvern Instruments. Residual moisture 136 ppm was determined at 230° C.

### I.3. Post Treatment Processes

### I.3.1. Washing Step (e1.1)

The cathode active material according to I.2. was poured into deionized water and stirred at ambient temperature for 5 minutes. The ratio of B-CAM.1—or C-B-CAM.2—to water was 2000 g/L. The resultant slurry was filtered, and a washed cathode active material CAM.W.1(2) was obtained by filtration and dried at 120° C. in air.

### I.3.2. Coating Step (e2.1)

The washed cathode active material CAM.W.1 (2) obtained according to 1.3.1. was mixed with 0.9 mole-% H₃BO₃ in a roller mill. The mole-% referred to the sum of Ni, Co, and Mn in the CAM.W.1 (2). The resultant mixture was then heated at 300° C. for 5 hours in a forced flow of oxygen to obtain the cathode active material CAM.1 or C-CAM.2, respectively.

SEM/EDX analysis revealed sub-micro sized coating particles (D50=100~ 500 nm) of Co compounds (B.1), which are island enriched on CAM.1 particle surface. TEM/EDX mapping of particle cross section confirmed no Co enrichment at the grain boundaries of primary particles. Surface sensitive XPS revealed a formation of boron shell (C) containing LiBO₂ and Li₂B₄O₇ phase at the secondary particle surface of CAM.1 and C-CAM.2, and the depth profile XPS revealed a boron coating depth to be several micro-meters along the grain boundaries of the primary particles.

Synchrotron-sourced X-ray diffractometer (ALBA Synchrotron Light Source, BL04-MSPD, Spain) was used for a high-resolution X-ray diffraction. Rietveld refinement using XRD pattern of CAM.1 revealed a formation of LiCoO₂ with a layered crystal structure.

### I.4 Further Examples

The protocol of 1.1 to 1.3 was repeated but with amounts of LiOH, Co(OH)₂, Al(OH)₃, ZrO₂, H₃BO₃ and WO₃ as indicated in Table 1.

TABLE 1
Data of further cathode active materials -
inventive and comparative

| | | Co | Al | Zr | W | B |
|---|---|---|---|---|---|---|
| CAM | Li/M | (mol %) | (mol %) | (mol %) | (mol-%) | (mol-%) |
| CAM.3 | 1.02 | 1.0 | 1.0 | 0.3 | 0.03 | 0 |
| C-CAM.4 | 1.02 | 0 | 1.0 | 0.3 | 0.03 | 0 |
| CAM.5 | 1.02 | 1.0 | 1.0 | 0.3 | 0 | 0.9 |
| C-CAM.6 | 1.02 | 0 | 1.0 | 0.3 | 0 | 0.9 |
| CAM.7 | 1.02 | 1.0 | 1.0 | 0.3 | 0.015 | 0.45 |
| C-CAM.8 | 1.02 | 0 | 1.0 | 0.3 | 0.015 | 0.45 |

### II. Testing of Cathode Active Material

### II.1. Electrode Preparation, General Procedure

### II.1.1. Cathode Preparation

PVDF binder (Solef® 5130) was dissolved in NMP (Merck) to produce a 7.5 wt. % solution. For electrode preparation, binder solution (3 wt. %), graphite (SFG6L, 2 wt. %), and carbon black (Super C65, 1 wt. %) were suspended in NMP. After mixing using a planetary centrifugal mixer (ARE-250, Thinky Corp., Japan), either inventive CAM.1 or comparative cathode active material C-CAM (94 wt. %) was added and the suspension was mixed again to obtain a lump-free slurry. The solid content of the slurry was adjusted to 65%. The slurry was coated onto Al foil using a roll-to-roll coater. Prior to use, all electrodes were calendared. The thickness of cathode material was 70 μm, corresponding to 15 mg/cm². All electrodes were dried at 105° C. for 7 hours before battery assembly.

### II. 1.2. Pouch Cell Anode Manufacture

Graphite and carbon black were thoroughly mixed. CMC (carboxymethyl cellulose) aqueous solution and SBR (styrene butadiene rubber) aqueous solution were used as a binder. The mixture of graphite and carbon black (weight ratio of cathode active material:carbon:CMC:SBR=96:0.5:2:1.5) was mixed with the binder solutions and an adequate amount of water to prepare a suitable slurry for electrode preparation. Thus, the obtained slurry was coated using a roll coater onto copper foil (thickness=10 μm) and dried under ambient temperature. The sample loading was fixed to be 10 mg/cm² for the single layer pouch cell testing.

### II.2. Electrolyte Preparation

A base electrolyte was prepared by mixing 12.7 wt. % LiPF₆, 26.2 wt. % ethylene carbonate (EC), and 61.1 wt. % ethyl methyl carbonate (EMC) (EL base 1), based on the total weight of EL base 1. To this base electrolyte formulation, 2 wt. % of vinylene carbonate (VC) was added (EL base 2).

### II.3. Test Cell Manufacture

### II.3.1. Coin-Type Half Cells

Coin-type half cells (20 mm in diameter and 3.2 mm in thickness) comprising a cathode prepared as described under II.1.1 and lithium metal as working and counter electrode, respectively, were assembled in an Ar-filled glove box. The cathode, anode, and separator were superposed in order of cathode//separator//Li foil to produce a half coin cell. Thereafter, 0.15 mL of EL base 1 as described under II.2. were added into the coin cell.

### II.3.2. Pouch Cells

Single layer pouch cells (70 mA·h) comprising an anode prepared as described in II.1.1, and a graphite anode according II. 1.2. were assembled and sealed in an Ar-filled glove box. The cathode and the anode and a separator were superposed in order of cathode//separator//anode to produce a single layer pouch cell. Thereafter, 0.8 mL of EL base 2 electrolyte were introduced into the laminate pouch cell.

### III. Evaluation of Cell Performance

### III.1. Evaluation of Coin Half-Cell Performance

Cell-performance were evaluated using the produced coin-type half cells. Initial capacity and capacity retention were measured as follows.

Coin-type half cells according to II.3.1. were tested in a voltage range between 4.3 and 2.7 C at room temperature. For the initial cycles, the de-lithiation was conducted in a CC-CV mode, i.e., a constant current (CC) of 0.05 C was applied followed by holding constant voltage (CV) at 4.3V until reaching 0.02 C. After 5 min resting, re-lithiation was carried out at a constant current of 0.05 C to 2.7V. For the cycling, the current density is C/3. The results are summarized in Table 2.

Single-layer pouch cells were tested after several formation cycles in a voltage range between 4.2 and 2.85V at C/3.

TABLE 2
Single-layer pouch cell performance (40° C. cycling)

| | Dis Cap. | Dis Cap. | Capacity | 100% SOC | 100% SOC | Resistance |
|---|---|---|---|---|---|---|
| | (C/3) at | (C/3) at | retention at | resistance at | resistance at | growth at |
| | 1^{st} cycle | 500^{th} cycle | 500^{th} cycle | 1^{st} cycle | 500^{th} cycle | 500^{th} cycle |
| Material | [mAh/g] | [mAh/g] | [%] | [Ω cm²] | [Ω cm²] | [%] |
| CAM.1 | 204 | 167 | 82 | 28 | 69 | 142 |
| C-CAM.2 | 204 | 163 | 80 | 30 | 123 | 312 |

As determined by SEM imaging, 20 to 45% of the particles of CAM.1 exhibit cracks after 500 cycles. More than 45% of the particles of C-CAM.2 exhibit cracks after 500 cycles.

1. A cathode active material comprising:
(A) a core material according to general formula Li₁₊ₓTM₁₋ₓO₂ wherein TM is a combination of Ni and at least two of Mn, Co and Al, and, optionally, at least one more metal selected from the group consisting of Mg, Ti, Zr, Nb, Ta, and W, and x is in the range of from −0.05 to +0.05, and wherein the nickel content is in the range of from 80 to 99 mol-% of TM,
(B) particles of cobalt compound(s) in which at least some cobalt is in the oxidation state of +III and selected from the group consisting of Li_{y1} CoO₂ with spinel structure,
LiCoO₂, and LiCo_{y2}Ni_{1-y2}O₂ wherein 0<y1<0.6 and 0.5<y2<1, and
(C) a shell comprising at least one compound selected from the group consisting of B₂O₃, WO₃, LiBO₂, Li₂B₄O₇, and Li₂WO₄,
wherein the core material (A) is a polycrystalline material whose secondary particles are composed of primary particles, and particles of cobalt compounds (B) are enriched at the surface of said secondary particles.

2. The cathode active material according to claim 1, wherein TM is a combination of transition metals according to general formula (I) 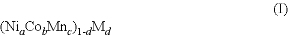
with
a being in the range of from 0.80 to 0.99,
b being in the range of from 0.005 to 0.12,
c being in the range of from 0.005 to 0.12, and
d being in the range of from zero to 0.1,
M is selected from the group consisting of Al, Mg, Ti, Zr, Nb, Ta, and W, and
$$a + b + c = 1 .$$

3. The cathode active material according to claim 1, wherein said particles of cobalt compound(s) comprise LiCoO₂.

4. The cathode active material according to claim 1, wherein 20 to 45% of the secondary particles exhibit cracks after 500 cycles of charging/discharging 4.2-3.0V in full cell with graphite anode at 40° C.

5. The cathode active material according to claim 1, wherein the particles (B) have an average diameter (D50) in the range of from 10 nm to 1 μm but in any case smaller than the diameter of core (A) when the average particle diameter (D50) is determined by SEM or TEM.

6. A process for making a cathode active material according to claim 1, comprising the steps of
(a) providing an oxide or (oxy) hydroxide of TM wherein TM is a combination of Ni and at least two of Mn, Co and Al, and, optionally, at least one more metal selected from the group consisting of Mg, Ti, Zr, Nb, Ta, and W, and wherein the nickel content is in the range of from 80 to 99 mol-% of TM,
(b) mixing said oxide or (oxy) hydroxide with an oxide or (oxy) hydroxide of cobalt selected from the group consisting of CoO, Co₃O₄, Co(OH)₂, CoOOH, and nonstoichiometric oxyhydroxides of cobalt, and, optionally, with at least one oxide or (oxy) hydroxide of Al, Nb, Ti or Zr, thereby obtaining a premix,
(c) adding a source of lithium to the premix obtained in step (b) in a molar ratio of Li to TM in the range of (1+x+y)/(1−x) wherein x is in the range of from zero to 0.05, and y is in the range of from zero to 0.1, thereby obtaining a mixture,
(d) calcining the mixture of step (c), and
(e) at least one post-treatment step selected from the group consisting of
(e1) treating calcined material from step (d) with water, followed by a liquid-solid separation step, and
(e2) adding a compound of B or W to the calcined material of step (d) or to the treated material from step (e1) and performing a thermal treatment at a temperature in the range of from 250 to 400° C., wherein the compound of B is selected from the group consisting of B₂O₃, boric acid (B(OH) 3) and lithium borates, and the compound of W is selected from the group consisting of WO₃, (NH₄) 2 WO₄, Liz WO₄, and Li₄WO₅.

7. The process according to claim 6, wherein step (d) is performed at a temperature in the range of from 550 to 800° C.

8. The process according to claim 6, wherein an oxide of TM with a moisture content in the range of zero to 100 ppm is provided in step (a), determined by Karl-Fischer titration.

9. The process according to claim 6, wherein steps (b) and (c) are performed in different mixer types.

10. The process according to claim 6, wherein step (b) is performed in the dry state.

11. The process according to claim 6, wherein TM is a combination of metals according to general formula (I) 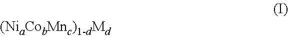
with
a being in the range of from 0.80 to 0.99,
b being in the range of from 0.005 to 0.12,
c being in the range of from 0.005 to 0.12, and
d being in the range of from zero to 0.1,
M is selected from the group consisting of Al, Mg, Ti, Zr, Nb, Ta, and W, and
$$a + b + c = 1 .$$

12. An electrode containing
(A) at least one cathode active material according to claim 1,
(B) carbon in electrically conductive form and
(C) a binder.

13. A secondary battery containing
(1) at least one electrode according to claim 12,
(2) at least one anode, and
(3) an electrolyte.
